(19) United States
(12) Patent Application Publication
(10) Pub. No.: US 2004/0059584 A1
(43) Pub. Date: Mar. 25, 2004

(54) Method for collecting and sharing knowledge in an organization

(76) Inventors: Songyee Yoon, Seoul (KR); Sanghoon Lee, Central (HK)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/254,019

(22) Filed: Sep. 25, 2002

(51) Int. Cl. G06F 17/60

(52) U.S. Cl. 705/1; 705/14

(57) ABSTRACT

The present invention is a method and apparatus for collecting and sharing knowledge in an organization by identifying members of the organization having the key knowledge assets and providing those members with a familiar tool to create and publish individual web pages expressing the key knowledge assets. In a preferred embodiment, members using the tools to share knowledge assets are rewarded based on a quality attribute of the web pages created.

### BACKGROUND OF THE INVENTION

1. Field of the Invention

The present invention relates generally to the field of knowledge management. More particularly, it relates to the business of collecting, managing and sharing valuable knowledge and experience possessed by certain members of an organization, such as, for example, a business or university. Still more particularly, the invention relates to methods and systems for identifying and collecting tacit knowledge assets from members of an organization and sharing those assets with other members (or non-members) of the organization via searchable, computer network-based, online knowledge management systems.

2. Related Art

Knowledge includes facts, data, information, intelligence, experience and wisdom. “Knowledge management” is often defined as “the way that organizations create, capture, modify and reuse knowledge to achieve organizational objectives.” W. Brock, Knowledge Management 101, 2i Trade Resource (Nov. 6, 2000). Knowledge management is also sometimes called “data mining” or “best practices sharing.” Conventional knowledge management systems almost always rely exclusively on structured knowledge repositories, such as libraries, document management systems, databases and expert systems, and the like. In rare instances, a conventional knowledge management system will also attempt to incorporate knowledge stored in unstructured repositories, such as project reports, photographs, letters, handwritten notes, e-mail and other sources.

It has been found, however, that much of the truly valuable knowledge existing within an organization, such as a university, government agency or business enterprise, has never been written down. As such, it resides only in the heads and minds of the people who work for the organization. This kind of knowledge, which is implied but unexpressed, is called “tacit” knowledge. And because it is intangible and so hard to get at using conventional methods, this tacit in-house knowledge is often completely overlooked, even though it may in fact comprise the organization's most valuable business asset.

Conventional knowledge management systems do a poor job of helping an organization collect, manage and share the tacit knowledge assets possessed by its members. Frequently, this is because conventional systems often require learning and using a set of complex and unfamiliar knowledge management tools and processes. Unfortunately, the members of an organization who possess the most valuable tacit knowledge are often the same people in the organization who are in the highest demand and/or have the most critical responsibilities. As such, they usually have very little time or motivation to interrupt or suspend their normal activities in order to actually use—much less get themselves trained to use—a set of complex and unfamiliar knowledge management tools and processes.

Moreover, members of the organization who, for one reason or another, do not currently hold positions of critical responsibility or high demand often do not recognize or appreciate the value of their knowledge and experience to the organization. Even if the value is recognized and appreciated, certain members of the organization may nevertheless be too intimidated by the complexity and unfamiliarity of conventional knowledge management systems, the prospect of having their opinions and abilities judged by other members of the organization, or both. Consequently, these members are also unlikely to use or contribute to the information contained in conventional knowledge management systems.

There are a number of other problems associated with conventional knowledge management systems. All too frequently, for example, conventional knowledge management projects fail to meet their objectives because the managers and supervisors of the organization fail to provide appropriate incentives to encourage members of the organization to document and share their knowledge and experiences with other members of the organization. Indeed, in many organizations, the perception may be that the most desirable positions and/or the largest financial rewards offered by the organization are more likely to go to the people who make a habit of hoarding knowledge and information, not those who make a habit of sharing it. Whether it is caused by the actual history of the organization, or by a failure of upper management to properly convey the importance of knowledge sharing, or to properly reward it, this perception remains an important obstacle, and sometimes a completely defeating obstacle, to an organization's attempts to achieve the benefits of knowledge management.

Conventional knowledge management systems often fail to meet their objectives for several other important reasons. In most cases, for instance, conventional knowledge management systems are not very well suited for capturing certain types of knowledge and information, including, for example, simple updates and announcements for on-going projects, minor tips and know-how, as well as personal experiences and background information, just to name a few. Even in the unlikely case that a conventional knowledge management system captures all of these types of information, it can still be very difficult, if not impossible, for other members of the organization to search for, locate and access that information in a timely and efficient manner.

Another shortcoming associated with conventional knowledge management systems is that it often takes too much time and quite a lot of effort by the users to codify the knowledge they possess. Users typically must answer many specific and sometimes irrelevant questions to meet the requirements of the specific system. This process is often very unpleasant and unfamiliar to users and sometimes discourages them from codifying and sharing tacit knowledge.

As will be described in detail below, the present invention overcomes the deficiencies and problems associated with conventional knowledge management systems.

### SUMMARY OF THE INVENTION

In general, the present invention is a method of collecting and sharing knowledge in an organization comprising the steps of: (1) determining a set of values; (2) identifying a set of knowledge assets that correlate to the set of values; (3) providing a web-authoring tool to a member of the organization who possesses a knowledge asset within the set of knowledge assets, the web-authoring tool being configured to facilitate creating a collection of web pages, where at least one web page in the collection is arranged to express the knowledge asset; and (4) publishing the collection of web pages on a computer network (which could be an intranet, the Internet, a local area network, or any other kind of computer network). This aspect may optionally include the step of rewarding the member based on an attribute of the collection of web pages, such as the quality of the web pages or the frequency with which they are accessed, for example.

The determination of the set of values, as well as the identification of knowledge assets, may be accomplished, but does not necessarily have to be accomplished, by interviewing a representative of the organization, reviewing a document generated by an official of the organization, conducting a survey, reviewing a trade publication, or consulting an expert in the particular field. This determination may also be made by performing some combination of one or more of all of these activities. Further, the step of providing a web-authoring tool to a member who possesses a knowledge asset may be accomplished in two substeps: (a) determining the identity of the member of the organization who possesses the knowledge asset; and (b) adapting the web-authoring tool to function in a manner consistent with a file processor with which the member is already familiar.

Preferably, the web-authoring tool includes a navigation panel configured to display a set of file identifiers, each one of the file identifiers in the set corresponding to a content object such as a text document, an audio or video data file, or a combination text, audio and video. The navigation panel is also configured to receive as an input a selected file identifier chosen from the set of displayed file identifiers. The selected file identifier corresponds to a selected content object. In a preferred embodiment, changing the logical layout of file identifiers and content objects in the navigation panel changes the logical layout of the collection of web pages, which allows the user to easily arrange the collection of the web pages in the fashion the user deems most effective for conveying knowledge.

The web-authoring tool also includes, in a preferred embodiment of this aspect of the present invention, a status panel configured to display the output of the file-processor, wherein the file processor is configured to create, delete, edit or modify the selected content object. Examples of suitable file-processors for this aspect of the present invention would include, for example, applications like Microsoft Word® and Microsoft PowerPoint®, both available from Microsoft Corporation of Redmond, Wash.

In a further aspect of the present invention, a search engine configured to search the collection of web pages in response to receiving a name, a keyword, a time-period, or the like, is provided. The search engine preferably produces a list of identifiers corresponding to individual web pages that meet the conditions specified with the name, keyword or time period, and the list may be sorted according to a specified user preference.

Another aspect of the present invention is a method of providing consulting services to an organization, comprising the steps of (1) identifying a set of knowledge assets that correlate to a set of values held by the organization; (2) developing an incentive plan designed to encourage members of the organization to publish web pages on a computer network which express at least one of the knowledge assets within the set of identified knowledge assets; and (3) facilitating publication of the collection of web pages.

In yet another aspect of the present invention, an apparatus for collecting and sharing knowledge in an organization is provided. The apparatus comprises means for determining a set of values; means for identifying a set of knowledge assets that correlate to the set of values; a web-authoring tool configured to facilitate creating a collection of web pages, at least one web page in the collection being arranged to express a knowledge asset within the identified set of knowledge assets; and means, responsive to the web-authoring tool, for displaying the collection of web pages to members of the organization. As stated above, the collection of web pages may be published on the Internet or any other interconnected computer network. But when there is a concern about the security or confidentiality of topics discussed in the web pages, users may choose to publish the web pages on an organization's secured intranet.

Features and Advantages of the Present Invention

It is a feature of the present invention that it provides a flexible, user-friendly method of collecting the tacit knowledge possessed by individual members of an organization and sharing that knowledge with other members of the organization via an online knowledge management system. The invention, being based on the concept of creating or facilitating the creation of individual home pages on an intranet or the Internet, does not require users to learn a complex and unfamiliar set of knowledge management tools. Thus, users have more time to focus on the quality of the information shared.

It is another feature of the present invention that members of the organization who use it to share knowledge and experiences are rewarded based on certain attributes of the shared knowledge and are further encouraged to continue or increase their level of participation in the knowledge management process for the organization.

Yet another feature of the present invention is that it provides a powerful and efficient search engine to facilitate online searches of the web pages created by using the knowledge management system based on certain keywords, timeframes, people, sources of information, and the like, which allows the user to sort the output in a variety of useful layouts.

An advantage of the present invention is that it requires only a minimal amount of time and effort for a member of the organization to learn. Consequently, the member may very quickly begin using the knowledge management system to create web pages containing valuable knowledge assets and publish those web pages on a computer network, such as an intranet, for access by other members of the organization.

Another advantage of the present invention is that the member who publishes the knowledge is free to decide the update frequency, format and level of detail his or her web pages will have.

Finally, users of the present invention do not need to know how to organize or label their knowledge assets because the process is handled by the intelligence of the search engine, which further reduces the time and effort required of those who are willing to share knowledge.

Additional features and advantages of the invention are set forth in part in the description that follows, and in part are apparent from the description, or may be learned by practice of the invention. The features and advantages of the invention may also be realized and attained by means of the instrumentalities and combinations particularly set out in the appended claims.

### BRIEF DESCRIPTION OF THE FIGURES

The accompanying drawings, which are incorporated in and constitute part of the specification, illustrate preferred embodiments of the invention, and, together with the description, serve to explain the principles of the present invention. In the drawings, like reference numbers indicate identical or functionally similar elements. Additionally, the left-most digit(s) of a reference number identifies the drawing in which the reference number first appears.

FIGS. 1A and 1B contain a flow diagram illustrating the steps that could be used to practice the present invention according to one embodiment.

FIG. 2 shows a block diagram of a knowledge management system configured in accordance with the present invention.

FIGS. 3A, 3B and 3C show an exemplary embodiment of a user interface display screen that could be used in a search engine provided in one embodiment of the present invention.

FIGS. 4A, 4B and 4C show an exemplary embodiment of a user interface display screen that could be used for interacting with the web-authoring tool provided in one embodiment of the present invention.

### DETAILED DESCRIPTION OF THE PREFERRED EMBODIMENTS

Reference will now be made in detail to the preferred embodiments of the invention, examples of which are illustrated in the accompanying drawings. Some embodiments of the methods and systems for knowledge management according to the present invention are shown in considerable detail, although it will be apparent to those skilled in the art that the present invention may be embodied in various other forms and with various other features not shown here for the sake of clarity. Therefore, the figures and examples shown below should not be interpreted as limiting the scope of the present invention or its embodiments or equivalents. Notably, the present invention may be implemented using software, hardware or any combination thereof, as would be apparent to those of skill in the art.

Detailed Operation of the Present Invention

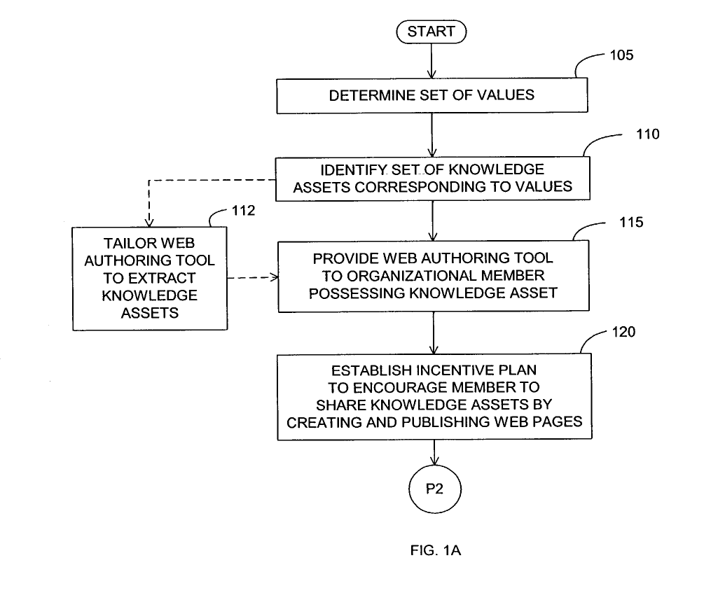

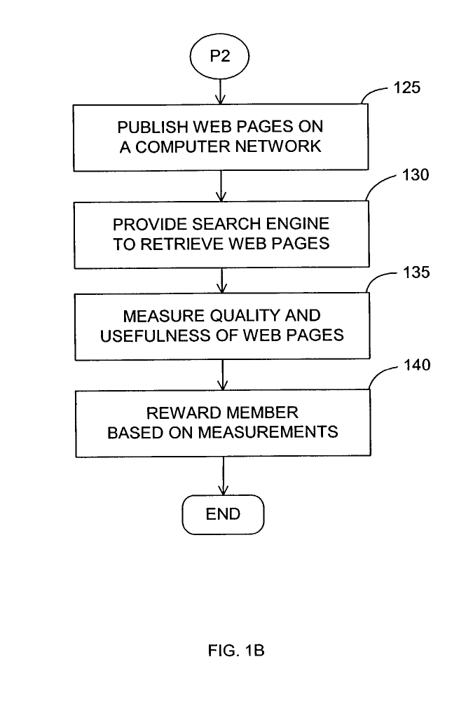

FIGS. 1A and 1B illustrate the general workflow of a method for collecting and sharing knowledge in an organization in accordance with one embodiment. First, when a knowledge management project is launched in an organization, a set of values important to the organization must be determined, step 105 of FIG. 1A. Regardless of whether the project is launched by in-house personnel or outside management consultants, efforts should be made during this step to thoroughly understand the overall objectives and specific business practices of the organization. Typically, although not necessarily, this step involves a number of startup activities, such as defining and agreeing on the scope of the knowledge management project, gathering exemplary documents and materials, and assigning personnel from the organization, from the outside consulting service, or both, to certain tasks related to identifying a core set of values held by the organization or, in some cases, held by organizations in similar positions or having comparable goals or business objectives.

In a preferred embodiment, the values may be determined, for example, by interviewing representatives of the organization, reviewing documents prepared by organization officials, conducting surveys, reviewing trade or industry publications or consulting with internal or external experts. In some cases, the organization or outside consultant may find it helpful or necessary to perform a combination of one or more of these activities, or all of them, in order to determine the relevant core value set for the organization.

The next step, shown as step 110 of FIG. 1A, is to identify a set of knowledge assets existing within the organization that correlate to the set of values determined in the previous step 105. Here again, it may advantageous, depending on the situation, to identify and interview knowledgeable representatives of the organization, review documents and literature prepared by industry or organization officials, conduct internal or external surveys, review trade or industry publications, or consult with experts and analysts in the particular field. The level of detail, as well as the relative order of performing these tasks typically depends on the situation. Structured repositories of knowledge assets, such as libraries, document management systems, databases and expert systems, and the like, may be used in this step, as well as unstructured repositories, such as project reports, photographs, letters, handwritten notes, e-mail and other materials, to help the organization or outside consultant identify key people or departments who possess valuable tacit knowledge assets.

As stated above, it is extremely helpful during this stage of the process to develop a thorough understanding of the overall objectives and the specific business practices used by the organization to achieve its goals. In some situations, conducting internal meetings and brainstorming sessions with key personnel of the organization during this stage may enhance the overall success of performing this step, and indeed, the entire knowledge management project. By the end of this stage, the organization or outside consultant should understand what the key knowledge assets are, where they reside in the organization (e.g., which people possess the key knowledge assets), and which of the key knowledge assets, in a broad sense, should be uploaded to the online knowledge management system so that they can be shared with other members of the organization.

The next step, step 115 in FIG. 1A, is to provide members of the organization possessing the key knowledge assets of the organization with a web-authoring tool configured to facilitate creating web pages designed to express those key knowledge assets. There are a number of web-authoring tools available in the marketplace that are already suitable or which may be adapted for use in creating the knowledge asset web pages. FrontPage® 2000, Sharepoint™ Team Services and Sharepoint™ Portal Services, available from Microsoft Corporation of Redmond, Wash. (www.microsoft.com), as well as HomeSite 5 and Dreamweaver MX, available from Macromedia, Inc. of San Francisco, Calif. (www.macromedia.com), for instance, represent just a few examples of commercial programs that may be used or adapted for these purposes by methods known to those of skill in the art.

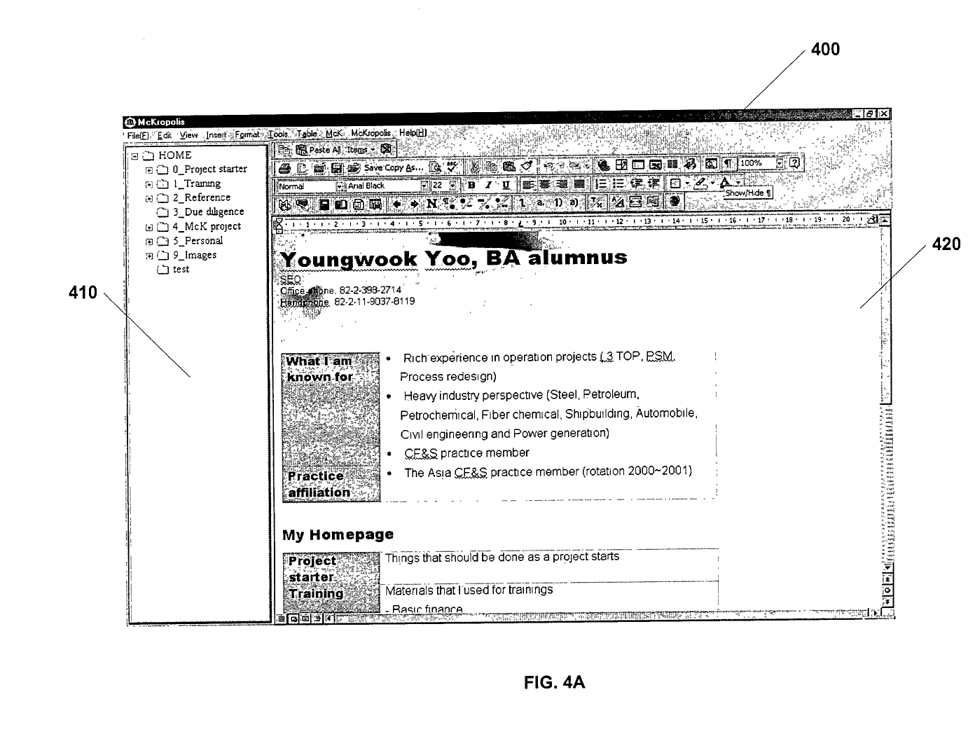

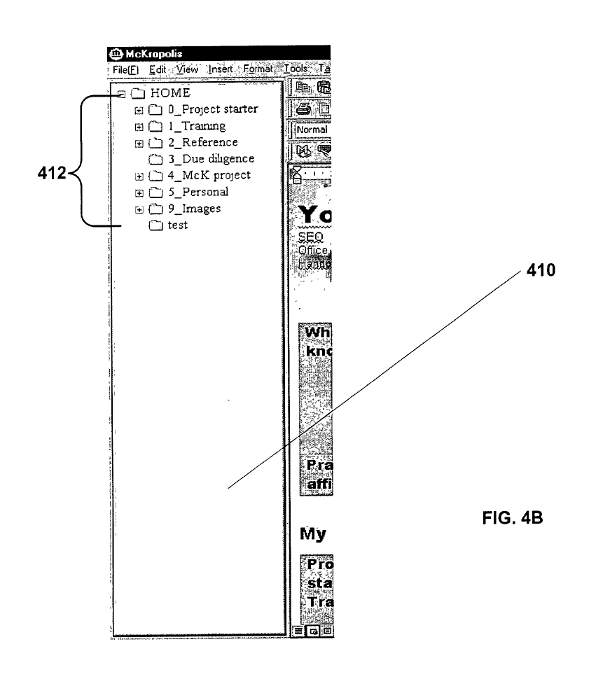

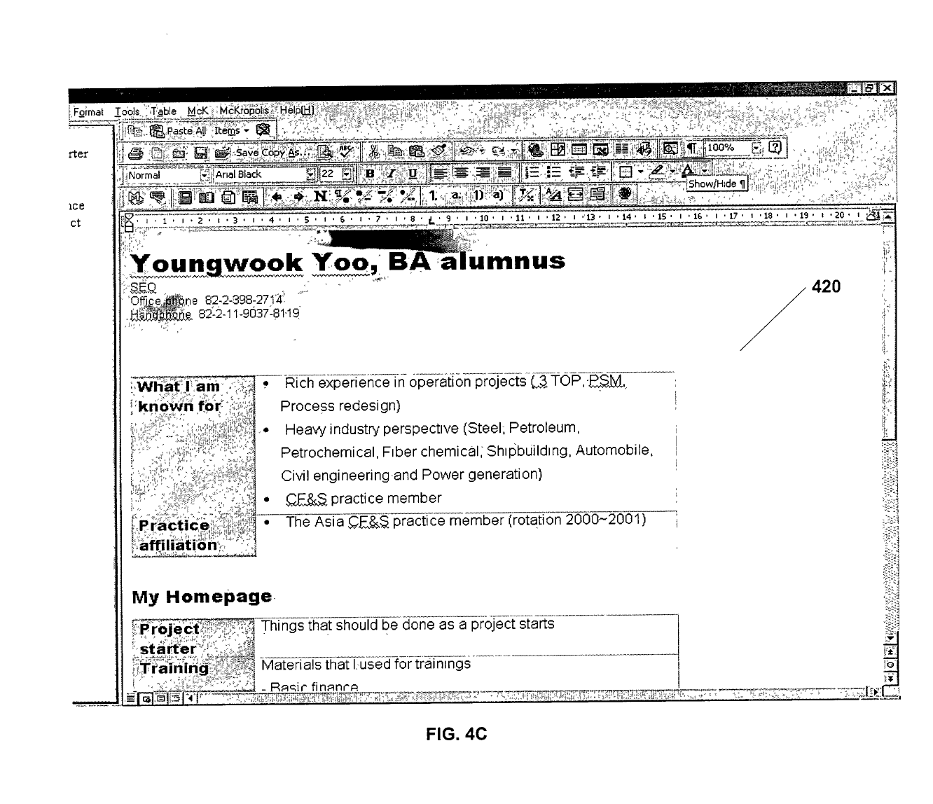

In a preferred embodiment, the web-authoring tool of the present invention, which may also be called a content editor, comprises a navigation panel configured to display a set of file identifiers corresponding to content objects, and to receive a selected identifier from a user corresponding to a selected content object. The tool also includes a status panel configured to display the output of a file-processor, such as Microsoft Word® or Microsoft PowerPoint®, also available from Microsoft Corporation (www.microsoft.com), configured to create, delete, edit or modify content objects. Preferred embodiments of a user interface for the web-authoring tool are described in more detail below with reference to FIGS. 4A, 4B and 4C.

As shown in step 112 of FIG. 1A, the web-authoring tool may optionally be tailored, modified or enhanced in order to make it more effective for extracting tacit knowledge assets from users of a particular organization. For example, the user interface of the web-authoring tool may be customized so that it is particularly well-suited to extract knowledge from people who are members of the accounting, engineering or testing department in an organization.

As another example, “templates” may be developed that include fields, such as project duration, industry of the client, team members worked with, major deliverables, etc., which are frequently used by members of a project team. These “templates” can be designed to help members of the organization easily and conveniently upload knowledge that is specific to their particular project or department in a larger organization. In a preferred embodiment, the use of these templates is optional, and members of an organization may decide to use them frequently, sparingly or not at all, depending on the nature of their work and the type of knowledge the organization seeks to preserve and share. Depending on the situation, other enhancements and modifications of the preferred web-authoring tool may be implemented according to methods known by those of skill in the art.

It has been found that knowledge management systems are much more effective when they are accepted and embraced by the people expected to use them for documenting and sharing their knowledge and expertise. As more people in the organization begin to accept and rely on the knowledge management system as a valuable tool for collecting and sharing information, the benefits for the organization begin to grow proportionally. To this end, and as noted in step 120 of FIG. 1A and step 135 of FIG. 1B, the benefits of implementing a knowledge management system in accordance with the present invention may be significantly enhanced by establishing an incentive plan designed to encourage members of the organization to use the knowledge management system (and the associated tools, such as the web-authoring tool) to create and share key knowledge assets with other members of the organization on a regular and frequent basis. The incentive plan may be implemented, for example, by promoting and/or recognizing members of the organization who excel at sharing useful knowledge assets with others, or by providing increased salaries and other financial rewards based on the quality and usefulness of web pages they create, as shown in steps 135 and 140 of FIG. 1B. This may also be accomplished, for example, by inviting users to participate in meetings, committees or organizations with people who are interested in or responsible for that particular area of the business. Some users may consider these activities very rewarding because they usually create great opportunities to increase one's visibility in the organization, to advance one's career, and play an important role in deciding how the organization works.

In a preferred embodiment, these measures can be integrated into the overall performance evaluation system for the members of the organization. In this way, upper management sends a clear and unmistakable signal to all members of the organization that participation in the knowledge management process is not only important, but will be recognized and rewarded.

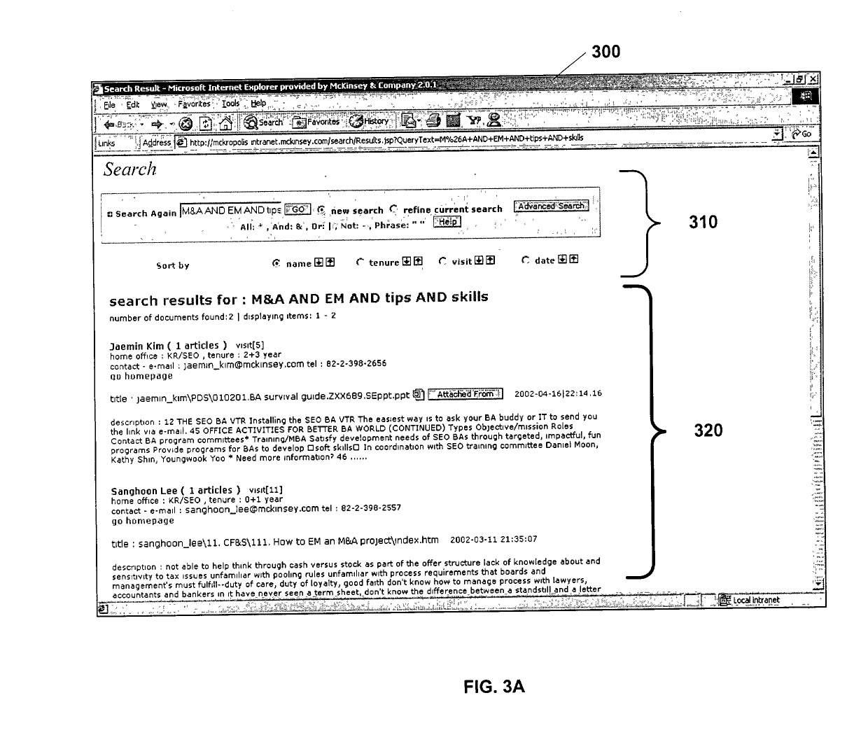

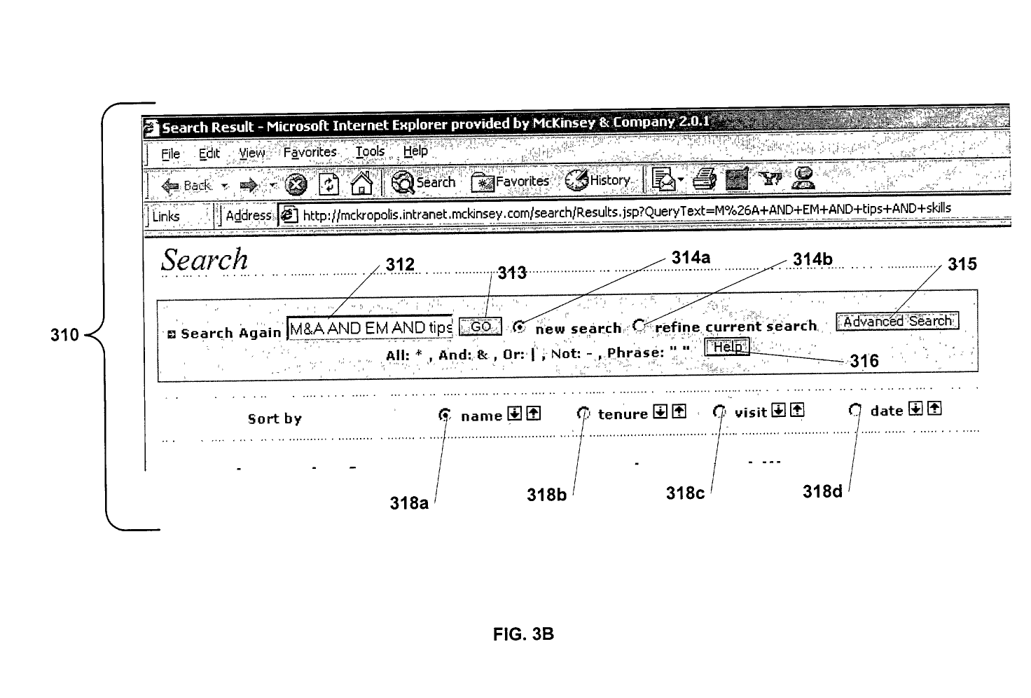

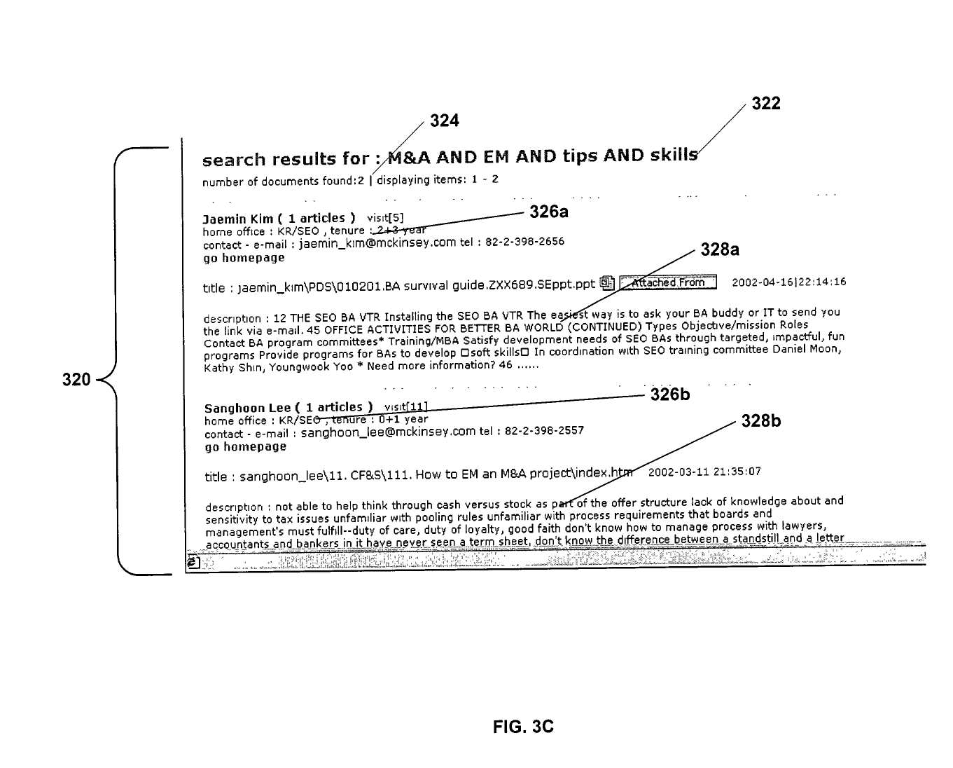

Returning now to FIGS. 1A and 1B, after providing members of the organization with the web-authoring tool (step 115), and establishing an incentive mechanism to use the web-authoring tool (step 120), the next step is to publish the web pages on a computer network (step 125 in FIG. 1B), and provide a search engine to retrieve the web pages (step 130). It should be evident to those of skill in the art, however, that one could change the order of steps 115, 120, 125 and 130 without departing from the scope of the invention. How the web pages are published using the web-authoring tool is described in more detail below with reference to FIGS. 4A-4C. How the search engine operates and displays search results is described in more detail below with reference to FIGS. 3A-3C.

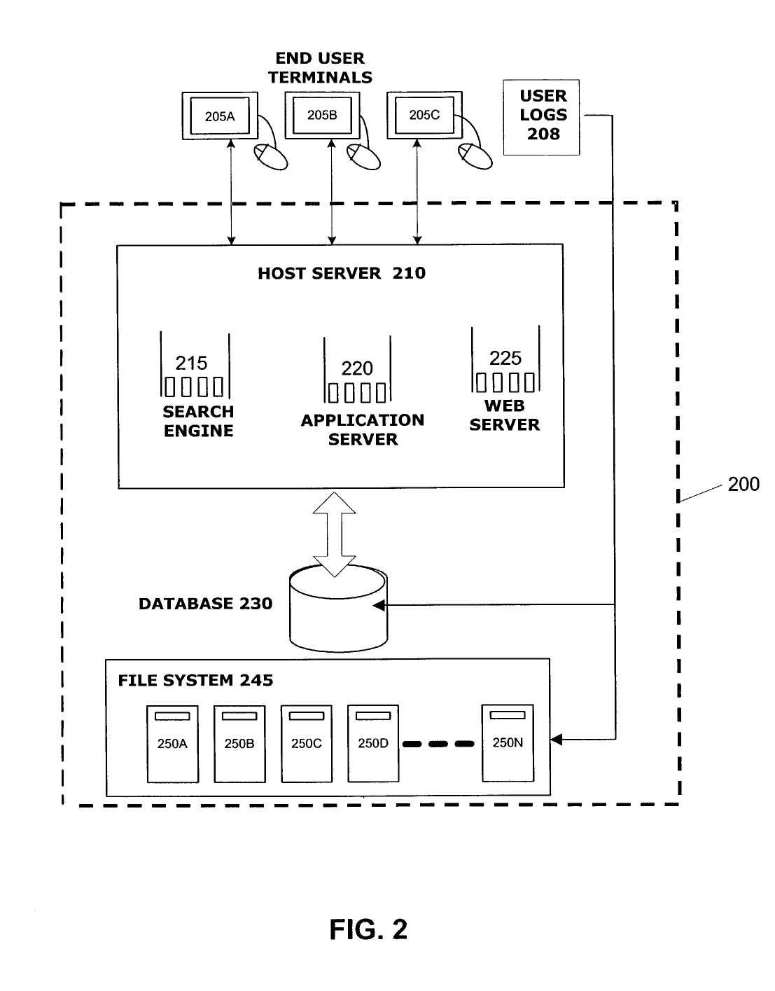

FIG. 2 contains a high-level block diagram of an online knowledge management system configured in accordance with a preferred embodiment of the present invention. As shown in FIG. 2, Online Knowledge Management System 200 comprises Host Server 210, Database 230 and File System 245. Host Server 210 may comprise a computer running an operating system, such as Windows 2000 or Windows NT (both available from Microsoft Corporation of Redmond, Wash.), or any other operating system capable of hosting an Internet or intranet web site. Users wishing to create and publish web pages in accordance with the present invention connect or log on to Host Server 210 from End User Terminals 205A, 205B and 205C (although any number of terminals could be used).

In a preferred embodiment, Host Server 210 comprises Search Engine 215, Application Server 220 and Web Server 225. Search Engine 215 is responsible for providing real-time search and browsing on knowledge asset-based web pages created and published by users. Verity, Inc., of Sunnyvale, Calif., provides search and categorization technology—as part of its “K2 Enterprise” solution—which is suitable for implementing such functionality in this embodiment of the present invention. Application Server 220 controls the content and appearance of the graphical user interface for Online Knowledge Management System 200 when users connect in order to publish additional web pages or perform searches on web pages published by other users. In a preferred embodiment, Application Server 220 not only controls the graphical user interface of Online Knowledge Management System 200, but also provides the business logic. JRUN, which is a popular application server available from Macromedia, Inc., of San Francisco, Calif., is one example of an application server that can be installed and configured to perform these functions in the present invention.

Application Server 220 works in conjunction with Web Server 225 to provide users with access to services such as viewing and downloading published web pages, performing file transfers and sending and receiving e-mail through Online Knowledge Management System 200. Internet Information Server (IIS), also available from Microsoft Corporation, may be used for this purpose, but web servers available from Sun Microsystems, of Mountain View, Calif., the Apache Software Foundation (www.apache.org), and others would work equally as well.

Online Knowledge Management System 200 preferably includes a relational database, depicted in FIG. 2 as Database 230, which supports structured query language (SQL) processing and manages online user web pages 250A through 250N, which reside in File System 245. In a preferred embodiment, user-initiated changes to local web pages residing on terminals 205A, 205B and 205C, are recorded in User Logs 208, which triggers updates of the user information contained in Database 230 and online user web pages 250A-250N. In a preferred embodiment, Search Engine 215 automatically indexes online user web pages 250A through 250N so that they can be easily and rapidly retrieved in response to search commands initiated by users.

FIGS. 3A, 3B and 3C show various components of a user interface screen for a search engine suitable for use with embodiments of the present invention. FIG. 3A shows the entire screen 300, including both user input area 310 and search result display area 320. FIG. 3B provides a close up view of input area 310, and FIG. 3C provides a close up view of the search results display area 320. The upper area of the interface screen 300, designated with reference number 310 in FIGS. 3A and 3B, contains input controls, such as text boxes, drop menus and radio buttons, for the user to provide new or modified search strings designed to locate information that may be contained in web pages that have been published in the online knowledge management system. In a preferred embodiment, and as shown in FIG. 3B, the user may initiate or modify a search by typing a search string into the text box area 312 and selecting the “go” button 313. The user may specify whether the search string is a new search string or a refinement of a previous search string by selecting one of the radio buttons 314a or 314b. For a more sophisticated search dialog, the user may select the “Advanced Search” button 315. The user may also obtain help by selecting Help Button 316. User input area 310 also provides, in a preferred embodiment, input controls for the user to select how the search results should be displayed. In this example, the search results may be sorted by name, tenure, the number of times the web page has been viewed (“visit”) or date by selecting one of the radio buttons 318a-d.

One could also choose to sort the search results by the owner of the web page, the method or source used to create the web page, the department or region of the author of the web page, a ranking of the web page, the contents of the web page, or some combination of one or more of these factors.

The lower portion of user interface screen 300, shown up close in FIG. 3C, illustrates an example of the type of search results a user may receive based on inputs provided in the above-described user input area 310. In this example, search results display area 320 displays the search string used (designated by reference number 322 in FIG. 3C), the number of hits found (area 324), the name and contact information for the authors of the web pages found as a result of the search (areas 326a and 326b), as well as a short description of the contents of the web pages found (areas 328a and 328b of FIG. 3C). Although the exact format of the search results may vary significantly without departing from the scope of the present invention, the ability to view results sorted by author, tenure and number of visits reduces the amount of time the user must spend reviewing results that are not meaningful to the specific task at hand. In a preferred embodiment, the collection of web pages are indexed and the indexes are saved in one or more relational or hierarchical database tables, according to methods well known by those skilled in the art, to facilitate fast retrieval by the search engine of web pages based on an author's name, his tenure or the number of visits to his web page.

FIGS. 4A, 4B and 4C show an exemplary user interface screen 400 for a web-authoring tool suitable for use with embodiments of the present invention. As shown in FIG. 4A, user interface screen 400 is divided into two regions, the navigation panel 410 and the status panel 420. FIG. 4A depicts the entire user interface screen 400, while FIGS. 4B and 4C contain close-up views of the navigation panel 410 and the status panel 420. Looking first at FIG. 4B, navigation panel 410 displays a set of file identifiers 412 corresponding to content objects (such as documents or files containing text, audio and video files for web pages), and allows the user to select, create and edit the overall arrangement of the set of web pages being created. In a preferred embodiment, changing the logical arrangement of the file identifiers 412 in area 410 results in changing the logical arrangement of the web page files represented by the file identifiers. This functionality makes it easy for a user to organize his or her web pages in the manner the user things is most effective.

Turning now to FIG. 4C, status panel 420 is configured, in a preferred embodiment, to display the output of a file-processing program capable of performing functions on the content object (e.g., Microsoft Word® for working with text, Microsoft Excel® for working with spreadsheets, or Adobe Photoshop® for working with images). In the example shown, the file processor is Microsoft Word, which performs editing functions on text documents. The file processor may also comprise, for instance, an audio player for creating, modifying, updating or deleting audio files, or an video editing program for creating, modifying, updating or deleting video images.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What is claimed is:

1. A method of collecting and sharing knowledge in an organization, comprising:
determining a set of values for the organization by performing at least one of the following substeps (a) through (e),
(a) interviewing a representative of the organization,
(b) reviewing a document generated by an official of the organization,
(c) conducting a survey,
(d) reviewing a trade publication,
(e) and consulting an expert;
identifying a set of knowledge assets that correlate to the set of values by performing at least one of the following substeps (f) through (j),
(f) interviewing a representative of the organization,
(g) reviewing a document generated by an official of the organization,
(h) conducting a survey,
(i) reviewing a trade publication,
(j) and consulting an expert;
providing a web-authoring tool to a member of the organization who possesses a knowledge asset within the set of knowledge assets, the web-authoring tool being configured to facilitate creating a collection of web pages, at least one web page in the collection being arranged to express the knowledge asset, wherein the web-authoring tool comprises
a navigation panel configured to display a set of file identifiers, each one of the file identifiers in the set corresponding to a content object, and to receive a selected file identifier selected from the set of file identifiers, the selected file identifier corresponding to a selected content object, and
a status panel configured to display an output of a file-processor configured to create, delete, edit or modify the selected content object;
establishing an incentive plan designed to encourage the member to create the collection of web pages;
publishing the collection of web pages on a computer network;
providing a search engine configured to search the collection of web pages in response to receiving a keyword, and to produce a list of identifiers, each identifier in the list corresponding to an individual web page within the collection of web pages which relates to the keyword; and
rewarding the member based on a quality aspect of the collection of web pages.

2. A method of collecting and sharing knowledge in an organization, comprising:
determining a set of values;
identifying a set of knowledge assets that correlate to the set of values;
providing a web-authoring tool to a member of the organization who possesses a knowledge asset within the set of knowledge assets, the web-authoring tool being configured to facilitate creating a collection of web pages, at least one web page in the collection being arranged to express the knowledge asset; and
publishing the collection of web pages on a computer network.

3. The method of claim 2, further comprising the step of rewarding the member based on an attribute of the collection of web pages.

4. The method of claim 2, wherein the determining step comprises performing at least one of the following steps,
interviewing a representative of the organization;
reviewing a document generated by an official of the organization;
conducting a survey;
reviewing a trade publication; and
consulting an expert.

5. The method of claim 2, wherein the identifying step comprises performing at least one of the following steps,
interviewing a representative of the organization;
reviewing a document generated by an official of the organization;
conducting a survey;
reviewing a trade publication; and
consulting an expert.

6. The method of claim 2, wherein the providing step comprises performing at least one of the following steps,
determining the identity of the member; and
adapting the web-authoring tool to function in a manner consistent with a file processor familiar to the member.

7. The method of claim 3, wherein the attribute is a quality aspect of the collection of web pages.

8. The method of claim 3, wherein the attribute comprises a tally of the number of times the collection of web pages is accessed.

9. The method of claim 3, wherein the attribute comprises a tally of the number of knowledge assets expressed in the collection of web pages.

10. The method of claim 3, wherein the attribute comprises a measurement of the extent to which the collection of web pages contributes to the set of values.

11. The method of claim 3, further comprising the step of monitoring changes in the attribute.

12. The method of claim 2, wherein the computer network comprises an intranet.

13. The method of claim 2, wherein the computer network comprises the Internet.

14. The method of claim 2, wherein the web-authoring tool is further configured to publish the collection of web pages.

15. The method of claim 2, wherein the web-authoring tool is further configured to synchronize the collection of web pages with a second collection of web pages.

16. The method of claim 3, further comprising the step of notifying the member of a reward.

17. The method of claim 2, further comprising the step of establishing an incentive plan designed to encourage the member to create the collection of web pages.

18. The method of claim 2, wherein the web-authoring tool comprises:
a navigation panel configured to display a set of file identifiers, each one of the file identifiers in the set corresponding to a content object, and to receive a selected file identifier selected from the set of file identifiers, the selected file identifier corresponding to a selected content object; and
a status panel configured to display an output of a file-processor configured to create, delete, edit or modify the selected content object.

19. The method of claim 18, wherein the web-authoring tool further comprises a formatter configured to generate a web-displayable object based on the selected content file.

20. The method of claim 19, wherein the formatter is invoked with a user-activatable switch.

21. The method of claim 19, wherein the web-authoring tool further comprises a publisher configured to transfer the web-displayable object to a web server.

22. The method of claim 21, wherein the publisher is invoked by a user-activatable switch.

23. The method of claim 19, wherein the web-authoring tool further comprises a version controller configured to synchronize the web-displayable object with a second web-displayable object residing on a web server.

24. The method of claim 23, wherein the version controller is invoked by a user-activatable switch.

25. The method of claim 2, further comprising the step of providing a search engine configured to search the collection of web pages in response to receiving a keyword, and to produce a list of identifiers, each identifier in the list corresponding to an individual web page within the collection of web pages which relates to the keyword.

26. The method of claim 2, further comprising the step of providing a search engine configured to search the collection of web pages in response to receiving a time-period, and to produce a list of identifiers, each identifier in the list corresponding to an individual web page within the collection of web pages which was created during the time-period.

27. The method of claim 2, further comprising the step of providing a search engine configured to search the collection of web pages in response to receiving a name, and to produce a list of identifiers, each identifier in the list corresponding to an individual web page within the collection of web pages which was created by a person having the name.

28. The method of claims 25, 26 or 27, wherein the list of identifiers is sorted according to at least one of the following,
an author for the individual web page;
an owner for the individual web page;
a method used to create the individual web page;
a source used to create the individual web page;
a tenure for the author of the individual web page;
a department for the author of the individual web page;
a region;
a ranking for the individual web page;
a frequency of access for the individual web page; and
the contents of the individual web page.

29. A method of collecting and sharing knowledge in an organization, comprising: determining a set of values;
identifying a set of knowledge assets that correlates to the set of values;
providing a web-authoring tool to a member of the organization who possesses a knowledge asset within the set of knowledge assets, wherein the web-authoring tool is
adapted to function in a manner consistent with a file processor familiar to the member, and
configured so that the member can create a collection of web pages, at least one web page in the collection being arranged to express the knowledge asset;
publishing the collection of web pages on a computer network.

30. The method of claim 29, wherein the web-authoring tool comprises:
a navigation panel configured to display a set of file identifiers, each one of the file identifiers in the set corresponding to a content object, and to receive a selected file identifier selected from the set of file identifiers, the selected file identifier corresponding to a selected content object; and
a status panel configured to display the output of a file-processor configured to create, delete, edit or modify the selected content object.

31. A method of providing consulting services to an organization, comprising:
identifying a set of knowledge assets that correlate to a set of values held by the organization;
developing an incentive plan to be implemented by the organization designed to encourage a member of the organization to publish a collection of web pages on a computer network, at least one web page in the collection being arranged to express a knowledge asset within the set of knowledge sets; and
providing a web-authoring tool to facilitate publishing the collection of web pages.

32. The method of claim 31, wherein the identifying step includes interviewing a representative of the organization to determine the set of values.

33. The method of claim 31, wherein a user interface for the web-authoring tool is configured to operate in a manner consistent with a user interface for a file processor used by the member.

34. The method of claim 31, wherein the web-authoring tool comprises:
a navigation panel configured to display a set of file identifiers, each one of the file identifiers in the set corresponding to a content object, and to receive a selected file identifier selected from the set of file identifiers, the selected file identifier corresponding to a selected content object; and
a status panel configured to display the output of a file-processor configured to create, delete, edit or modify the selected content object.

35. The method of claim 31, wherein the collection of web pages is published on a computer network configured for access by other members of the organization.

36. The method of claim 31, wherein the collection of web pages is published on a computer network configured for access by people outside the organization.

37. The method of claim 31, wherein the computer network comprises an intranet.

38. The method of claim 31, wherein the computer network comprises the Internet.

39. An apparatus for collecting and sharing knowledge in an organization, comprising:
means for determining a set of values;
means for identifying a set of knowledge assets that correlate to the set of values;
a web-authoring tool configured to facilitate the creation of a collection of web pages, at least one web page in the collection being arranged to express a knowledge asset within the identified set of knowledge assets; and
means, responsive to the web-authoring tool, for displaying the collection of web pages to members of the organization.

40. The apparatus of claim 39, further comprising means for rewarding the author of the collection of web pages based on an attribute of the collection of web pages.

41. The apparatus of claim 40, wherein the attribute is a quality aspect of the collection of web pages.

42. The apparatus of claim 40, wherein the attribute comprises a tally of the number of times the collection of web pages is accessed.

43. The apparatus of claim 40, wherein the attribute comprises a tally of the number of knowledge assets expressed in the collection of web pages.

44. The apparatus of claim 40, wherein the attribute comprises a measurement of the extent to which the collection of web pages contributes to the set of values.

45. The apparatus of claim 39, wherein the web-authoring tool comprises:
a navigation panel configured to display a set of file identifiers, each one of the file identifiers in the set corresponding to a content object, and to receive a selected file identifier selected from the set of file identifiers, the selected file identifier corresponding to a selected content object; and
a status panel configured to display the output of a file-processor configured to create, delete, edit or modify the selected content object.
